(19) United States
(12) Patent Application Publication
(10) Pub. No.: US 2010/0095257 A1
(43) Pub. Date: Apr. 15, 2010

(54) ELECTROMAGNETIC FIELD ANALYSIS OF SEMICONDUCTOR PACKAGE WITH SEMICONDUCTOR CHIP MOUNTED THEREON

(75) Inventors: Kazutaka Koshiishi, Tokyo (JP); Mitsuaki Katagiri, Tokyo (JP); Satoshi Isa, Tokyo (JP)

Correspondence Address: FOLEY AND LARDNER LLP;SUITE 500, 3000 K STREET NW, WASHINGTON, DC, 20007, US

(73) Assignee: Elpida Memory, Inc.

(21) Appl. No.: 12/574,980

(22) Filed: Oct. 7, 2009

(30) Foreign Application Priority Data
Oct. 9, 2008 (JP) 2008-263199

(51) Int. Cl. G06F 17/50

(52) U.S. Cl. 716/5

(57) ABSTRACT

An electromagnetic field analysis of a semiconductor package with a semiconductor chip mounted thereon can be performed simply with a high accuracy. First modeling and second modeling of the semiconductor package with the semiconductor chip mounted thereon are carried out, thereby performing first and second electromagnetic field analyses. Results of the first and second electromagnetic field analyses are synthesized to determine electrical characteristics of the semiconductor package. Specifically, an inductance analysis is performed with the entire semiconductor chip regarded as a dielectric, thereby determining an inductance component of an equivalent circuit. A capacitance analysis is performed with the semiconductor chip regarded as a dielectric having a metal thin film on its surface, thereby determining a capacitance component of an equivalent circuit. Results of the inductance analysis and the capacitance analysis are synthesized to determine an equivalent circuit.

### REFERENCE TO RELATED APPLICATION

This application is based upon and claims the benefit of the priority of Japanese patent application No. 2008-263199 filed on Oct. 9, 2008, the disclosure of which is incorporated herein in its entirety by reference thereto.

### BACKGROUND OF THE INVENTION

1. Field of the Invention

The present invention relates to a semiconductor package electromagnetic field analysis method, a semiconductor package electromagnetic field analysis device, and a semiconductor package electromagnetic field analysis program. More specifically, the invention relates to electromagnetic field analysis of a semiconductor package with a semiconductor chip mounted thereon.

2. Description of Related Art

Traditionally, in order to investigate the influence of a semiconductor package including a semiconductor chip on characteristics of the semiconductor chip, determination of electrical characteristics and an equivalent circuit of the semiconductor package using an electromagnetic field analysis has been made. Patent Document 1, for example, describes determination of an equivalent circuit of an overall semiconductor package by dividing the semiconductor package into a plurality of basic shapes, determining an S parameter by electromagnetic simulation for each basic shape, determining the circuit constant of an equivalent circuit corresponding to the basic shape by fitting the S-parameter, and finally synthesizing the circuit constants.

The structure of a semiconductor package targeted for electromagnetic field analysis will be described. FIG. 1 is a sectional view of a common semiconductor package that uses a four-metal-layer substrate and wire bonding. In the semiconductor package, a semiconductor chip 1 is mounted on a package wiring substrate 23, and surfaces of the semiconductor chip 1 are covered with a mold resin 4. In the package wiring substrate 23, a signal wiring layer 8 and a power supply wiring layer 10 are respectively provided on the surface and underside of a substrate member 9. Further, ground (GND) wiring layers (6, 12) are respectively provided over the surface of the signal wiring layer 8 and the underside of the power supply wiring layer 10 through dielectric layers 14, thereby forming a four-wiring-layer grid wiring substrate. The surface and underside of the package wiring substrate 23 are respectively covered with solder resists (7, 11).

The semiconductor chip 1 is fixed to the package wiring substrate 23 through a die-attach member 5. Wirings on the semiconductor chip 1 are electrically connected to a wiring layer on the package wiring substrate 23 by bonding wires 3 from semiconductor chip pads 2 on the surface of the semiconductor chip 1 and are further connected to solder balls 13 on the underside of the package wiring substrate 23. In the semiconductor package described in FIG. 1, the wiring layer of the package wiring substrate 23 closest to the semiconductor chip 1 is the ground (GND) wiring layer 6. Thus, the ground (GND) wiring layer 6 serves as a shield. The influence of signal wirings of the package wiring substrate 23 on electrical characteristics of the semiconductor chip 1 and the influence of the presence of the semiconductor chip 1 on electrical characteristics of the signal wirings of the package wiring substrate 23 and the like can be thereby reduced.

Next, FIG. 2 is a sectional view of a semiconductor package that uses a one-metal-layer wiring substrate. The semiconductor package in FIG. 2 is different from the semiconductor package that uses the four-layer wiring substrate in FIG. 1 in that signal wirings, power supply wirings, and ground wirings are wired on a wiring layer 16 of one layer in place of the signal wiring layer 8, power supply wiring layer 10, and ground wiring layers (6, 12). Devices and the semiconductor chip pads 2 are formed on a surface of the semiconductor chip 1 that faces a package substrate. The devices and the semiconductor chip pads 2 are face-down mounted on the package substrate. Other respects are substantially the same as in the semiconductor package in FIG. 1.

FIG. 3 is a pattern diagram that enlarge and show a sectional structure of a semiconductor chip surface in the sectional view of the semiconductor package in FIG. 2. Portion (a) of FIG. 3 shows a portion of the sectional view of the semiconductor package in FIG. 2. Portion (b) of FIG. 3 enlarges and shows a device formation surface of the semiconductor chip 1 in portion (a) of FIG. 3. Portion (c) of FIG. 3 further enlarges and shows a transistor structure of the semiconductor chip 1 in portion (b) of FIG. 3. As illustrated in (a) of FIG. 3, the thickness of an overall portion of the semiconductor package is several millimeters. A die-attach member and a substrate member 9 are provided between the semiconductor chip 1 and a package wiring layer 16. The thickness of the die-attach member is several hundred μm. Further, as illustrated in (b) of FIG. 3, metal wiring layers 19 having a thickness of approximately several μm are provided for a diffusion layer 17 of the semiconductor chip 1. The metal wiring layers 19 are via-connected to the diffusion layer 17. The distance from the metal wiring layer 19 to the package wiring layer 16 may be 1 mm or less. As shown in (c) of FIG. 3, a transistor having a thickness of several hundred nm is formed on the surface of the diffusion layer 17. The structure of the surface of the semiconductor chip 1 shown in (b) and (c) of FIG. 3 is the same as in FIG. 1.

[Patent Document 1] JP Patent Kokai Publication No. JP-A-8-51134

### SUMMARY

The entire disclosure of Patent Document 1 is incorporated herein by reference thereto.

An analysis is given by the present invention as follows.

It is necessary to reproduce the structure and material properties of an analysis target into an analysis model in order to analyze the wiring capacitance and inductance of a semiconductor package in electromagnetic field simulation with a higher accuracy. However, when the model is elaborated, the size or time of the analysis may increase, or the analysis may not be performed. Further, even if the model is elaborated, the accuracy of the analysis may be scarcely increased.

In the electromagnetic field simulation in particular, handling of the semiconductor chip mounted on the semiconductor package may become a problem. Since silicon in the semiconductor chip is a semiconductor having a dielectric constant of 12 and a conductivity of several dozen S/m, silicon cannot be defined as a conductor nor a dielectric material. Accordingly, the semiconductor chip cannot be readily taken in for the electromagnetic field simulation.

Further, a circuit into which an insulating layer such as that formed of SiO₂ and other metal are intricately incorporated is formed on a silicon substrate of the semiconductor chip. Thus, when the influences of the insulating layer and the other metal are to be reproduced into the analysis model in order to analyze the wiring capacitance and inductance of the semiconductor package with high accuracy, a problem that the analysis cannot be performed arises due to complexity of the structure and material properties of the analysis target.

That is, as explained using FIG. 3, the size of the transistor is several hundred nm while the thickness of the semiconductor package is on the order of several mm. Thus, there is a size difference of approximately 10000 times between the size of the transistor and the thickness of the semiconductor package. Further, there is a similar size difference in an in-plane direction as well as in a sectional direction. When an analysis is performed by modeling the transistor as described above having the size which is 1/10000 of the thickness of the semiconductor package so as to analyze the semiconductor package with good accuracy, the size of the analysis may become enormous. The analysis is not therefore realistic.

FIG. 4 is a diagram showing an electromagnetic field analysis procedure of a semiconductor package that has been so far conceived and a problem of the procedure. Generally, in step S104, an analysis is performed using only a package substrate model without generating a semiconductor chip model. When good accuracy of the analysis is not achieved using only the package substrate model, the entire semiconductor chip may be regarded as one dielectric or conductor and may be incorporated into the semiconductor package substrate model to perform electromagnetic field simulation in step S109. However, even if such modeling is carried out, electrical characteristics obtained by the modeling may differ from actual electrical characteristics of the semiconductor package. When there is no conductive layer that serves as a shielding layer between the semiconductor chip 1 and the signal wiring layer of the package substrate as in the semiconductor package in FIG. 2, the presence of the semiconductor chip 1 influences characteristics of the package substrate.

In recent years in particular, the thickness of the semiconductor package itself is reduced due to high-density mounting. Thus, the distance between the semiconductor chip and the wiring layer of the package substrate is reduced. Thus, the influence of the semiconductor chip on the characteristics of the package substrate has become pronounced. Electrical characteristics obtained by using a package equivalent circuit model obtained in step S108 or S114 that has been conceived so far in FIG. 4 may therefore differ from the actual electrical characteristics of the semiconductor package. Accordingly, there is much to be desired in the art.

According to one aspect of the present invention, there is provided an electromagnetic field analysis method of semiconductor package of performing an electromagnetic field analysis of a semiconductor package with a semiconductor chip mounted thereon, thereby determining electrical characteristics of the semiconductor package. The method includes: carrying out first modeling of a semiconductor chip, thereby performing a first electromagnetic field analysis of a semiconductor package; and carrying out second modeling of the semiconductor chip, thereby performing a second electromagnetic field analysis, the second modeling being different from the first modeling. The method further includes: determining the electrical characteristics of the semiconductor package with the semiconductor chip mounted thereon from results of the first electromagnetic field analysis and the second electromagnetic field analysis.

According to another aspect of the present invention, there is provided a semiconductor package electromagnetic field analysis device, which includes: a semiconductor-chip-mounted semiconductor package model generation unit that receives a substrate model of a semiconductor package and design data on a semiconductor chip to be mounted on the semiconductor package, and then generates first and second models of the semiconductor package with the semiconductor chip mounted thereon. The device further includes: an electromagnetic field analysis unit that performs an electromagnetic analysis of each of the first model and the second model and outputs a result of the first electromagnetic field analysis and a result of the second electromagnetic field analysis. The device further includes: an electromagnetic field analysis result synthesis unit that synthesizes the result of the first electromagnetic field analysis and the result of the second electromagnetic field analysis, thereby outputting electrical characteristics of the semiconductor package with the semiconductor chip mounted thereon.

According to still another aspect of the invention, there is provided a computer-readable storage medium storing a semiconductor package electromagnetic field analysis program causes a computer to execute the semiconductor package electromagnetic field analysis method described above. According to another aspect of the invention, there is provided a computer-readable storage medium storing a semiconductor package electromagnetic field analysis program causes a computer to function as the semiconductor package electromagnetic field analysis device described above.

The meritorious effects of the present invention are summarized as follows.

According to the present invention, the electrical characteristics of the semiconductor package with the semiconductor chip mounted thereon are determined from the result of the electromagnetic field analysis by carrying out first modeling of the semiconductor chip and the result of the electromagnetic field analysis by carrying out second modeling of the semiconductor chip. Thus, the electrical characteristics of the semiconductor package can be determined comparatively simply, with a high accuracy.

### BRIEF DESCRIPTION OF THE DRAWINGS

FIG. 1 is a sectional view of a common semiconductor package that uses a four-metal-layer substrate and wire bonding;

FIG. 2 is a sectional view of a semiconductor package that uses a one-metal-layer wiring substrate;

FIG. 3 is a pattern diagram of the semiconductor package in FIG. 2, portion (a) of FIG. 3 shows sectional structure of the semiconductor package, and portions (b) and (c) of FIG. 3 show enlarged sectional structures of a surface of a semiconductor chip;

FIG. 4 is a diagram explaining a problem of the present invention;

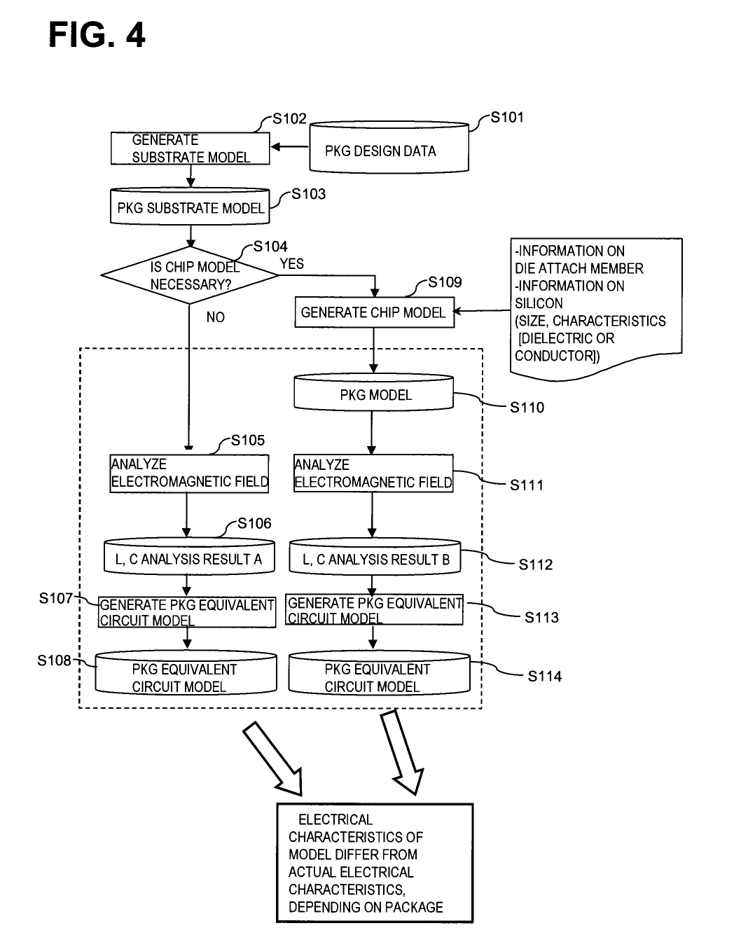

FIG. 5 is a diagram showing a configuration of an electromagnetic analysis device according to an example of the present invention;

FIG. 6 is a flow chart showing an electromagnetic analysis method according to an example of the present invention;

FIGS. 7A to 7C are diagrams schematically showing models of a semiconductor package in an example of the present invention, in which FIG. 7A is a package substrate model not including a semiconductor chip, FIG. 7B is an inductance analysis model including the semiconductor chip, and FIG. 7C is a capacitance analysis model including the semiconductor chip;

FIG. 8 is a circuit diagram showing a portion of a semiconductor package substrate equivalent circuit according to an example of the present invention;

FIG. 9 is a sectional view of a wafer level chip size semiconductor package (WLCSP);

FIG. 10 is a diagram showing a configuration of an electromagnetic analysis device according to another example of the present invention; and

FIG. 11 is a flowchart showing an electromagnetic analysis method according to an example of the present invention.

### PREFERRED MODES

In the semiconductor package electromagnetic field analysis method according to an exemplary embodiment of the present invention, an entire portion of the semiconductor chip is modeled as a dielectric in the first modeling, and inductance characteristics of the semiconductor package are determined by the first electromagnetic field analysis; and in the second modeling, the semiconductor chip is modeled as a dielectric with a metal thin film provided on an overall surface of the semiconductor chip where wiring layers are provided, and capacitance characteristics of the semiconductor package are determined by the second electromagnetic field analysis.

In the semiconductor package electromagnetic field analysis method according to an exemplary embodiment of the present invention, an inductance equivalent circuit of the semiconductor package is determined by the first electromagnetic field analysis; a capacitance equivalent circuit of the semiconductor package is determined by the second electromagnetic field analysis; and the step of determining the electrical characteristics of the semiconductor package includes a step of determining an equivalent circuits of the semiconductor package. That is, when the equivalent circuit is determined, the electrical characteristics can be uniquely determined. Thus, the equivalent circuit in the present invention is one form of expression of the electrical characteristics.

The semiconductor package electromagnetic field analysis method according to an exemplary embodiment of the present invention targets the semiconductor package in particular which is structured such that a wiring layer of a package substrate is in proximity to the wiring layers provided on the surface of the semiconductor chip with a distance of 1 mm or less through an insulating layer. This target setting is made because, when the distance is short, electrical characteristics and an equivalent circuit of the wiring layer of the package substrate are readily subject to the influence of the wiring layers provided on the surface of the semiconductor chip.

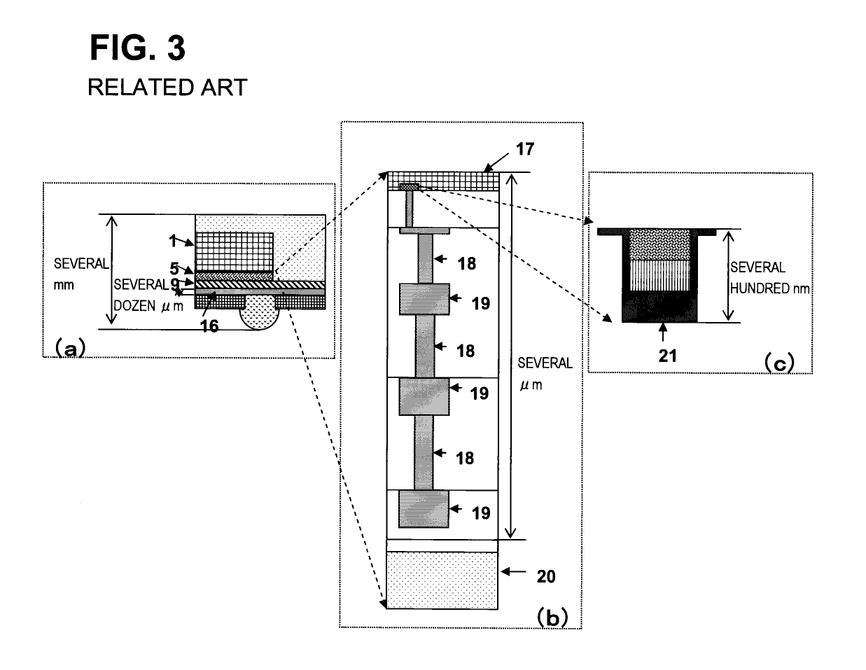

The semiconductor package electromagnetic field analysis method according to an exemplary embodiment of the present invention targets the package in particular where no conductive layer is present between the wiring layer of the package substrate (indicated by reference numeral 16 in FIG. 3, for example) and the wiring layers (indicated by reference numeral 19 in FIG. 3) provided on the surface of the semiconductor chip being in proximity to each other through the insulating layer, a potential being supplied to the conductive layer from outside at a time of operation. When there is no conductive layer that serves as a shield between the wiring layer provided on the surface of the semiconductor chip and the wiring layer of the package substrate, the wiring layer of the package substrate is readily subject to the influence of the wiring layer provided on the surface of the semiconductor chip.

The semiconductor package electromagnetic field analysis method according to an exemplary embodiment of the present invention targets the semiconductor package that is a wafer level chip size package, in particular. This target setting is made because, since the distance between the semiconductor chip and the wirings of the package substrate is short, the wirings of the package substrate are readily subject to the influence of the semiconductor chip.

In a semiconductor package electromagnetic field analysis device according to an exemplary embodiment of the present invention, a semiconductor-chip-mounted semiconductor package model generation unit generates as a first model a model that regards an entire portion of a semiconductor chip as a dielectric, and generates as a second model a model that regards the semiconductor chip as a dielectric with a thin film conductor provided on an overall surface of the semiconductor chip where at least a wiring layer is provided. Then, an electromagnetic field analysis unit performs an electromagnetic field analysis of the first model and outputs an inductance analysis result of the semiconductor package as a first electromagnetic analysis result, and performs an electromagnetic field analysis of the second model and outputs a capacitance analysis result of the semiconductor package as a second electromagnetic field analysis result.

In the semiconductor package electromagnetic field analysis device according to an exemplary embodiment of the present invention, the electromagnetic field analysis unit performs the electromagnetic field analysis of the first model and then outputs an inductance component equivalent circuit of the semiconductor package as the first electromagnetic field analysis result, and performs the electromagnetic field analysis of the second model and then outputs a capacitance component equivalent circuit of the semiconductor package as the second electromagnetic field analysis result. Then, the electromagnetic field analysis result synthesis unit synthesizes the inductance component equivalent circuit and the capacitance component equivalent circuit, thereby outputting an equivalent circuit of the semiconductor package, as electrical characteristics of the semiconductor package. Examples of the present invention will be described below in detail with reference to drawings.

### First Example

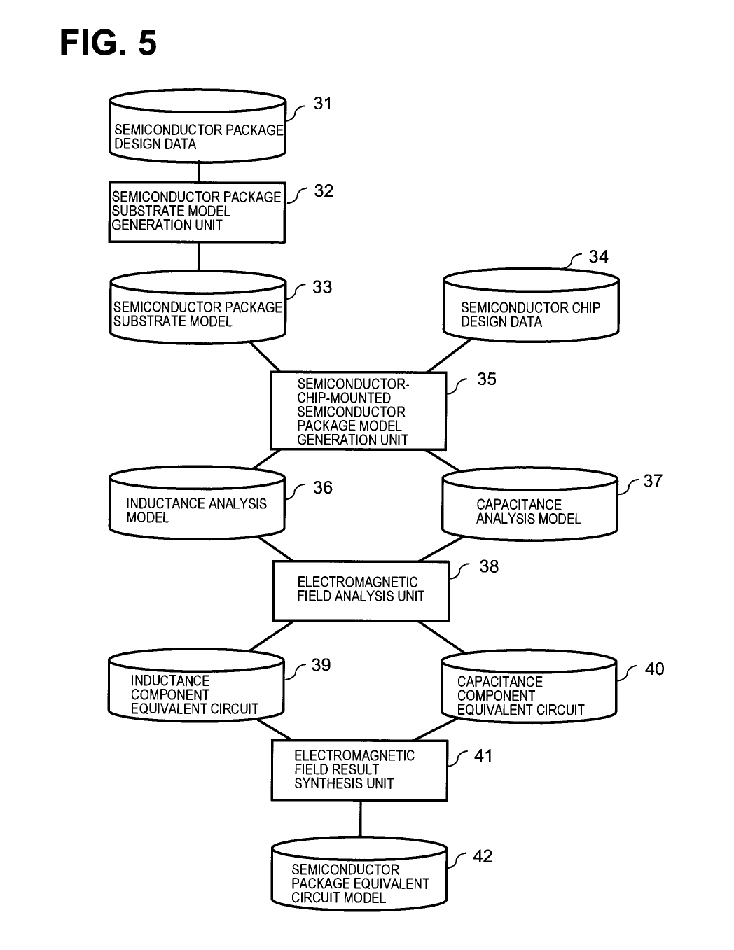

FIG. 5 is a configuration diagram of an electromagnetic field analysis device according to a first example of the present invention. The semiconductor package analysis device in FIG. 5 includes a semiconductor package substrate model generation unit 32 that receives design data 31 on a semiconductor package and then outputs a semiconductor package substrate model 33. The semiconductor package substrate model 33 generated by this semiconductor package substrate model generation unit 32 does not include a semiconductor chip model. Thus, a semiconductor package substrate model that has been used for conventional electromagnetic field analysis can be used without alteration. The substrate model 33 includes information on wiring pattern shapes, dielectric constants of a substrate member 9, a solder resist 11, and the like, resistivity of substrate wirings, and a boundary condition about connections to the ground and signal terminals.

A semiconductor-chip-mounted semiconductor package model generation unit 35 receives the semiconductor package substrate model and semiconductor chip design data 34, and then outputs an inductance analysis model 36 and a capacitance analysis model 37 obtained by adding the semiconductor chip model to the semiconductor package substrate model 33. The semiconductor chip design data 34 includes information on the chip size of a semiconductor chip, necessary for modeling the semiconductor chip. Further, when information necessary for modeling an overall portion of the semiconductor package such as the quality and thickness of a die attach member except the semiconductor package substrate model 33 and the semiconductor chip design data is deficient as data to be supplied to the semiconductor-chip-mounted semiconductor package model generation unit 35, the information may be supplied in this stage.

Next, an electromagnetic field analysis unit 38 receives the inductance analysis model 36 and outputs an inductance component equivalent circuit 39. The inductance component equivalent circuit 39 includes self inductance components of conductor patterns of the semiconductor package and mutual inductance components between the conductor patterns. The inductance component equivalent circuit 39 also includes resistive components of the conductor patterns.

The electromagnetic field analysis unit 38 receives the capacitance analysis model 37, and then outputs a capacitance component equivalent circuit 40. The capacitance component equivalent circuit 40 includes mutual capacitance components between the conductor patterns included in the semiconductor package.

An electromagnetic field analysis result synthesis unit 41 receives the inductance component equivalent circuit 39 and the capacitance component equivalent circuit 40, thereby outputting a semiconductor package equivalent circuit model 42. That is, the electromagnetic field analysis result synthesis unit 41 synthesizes the inductance component equivalent circuit and the capacitance component equivalent circuit, thereby generating the equivalent circuit of the overall semiconductor package.

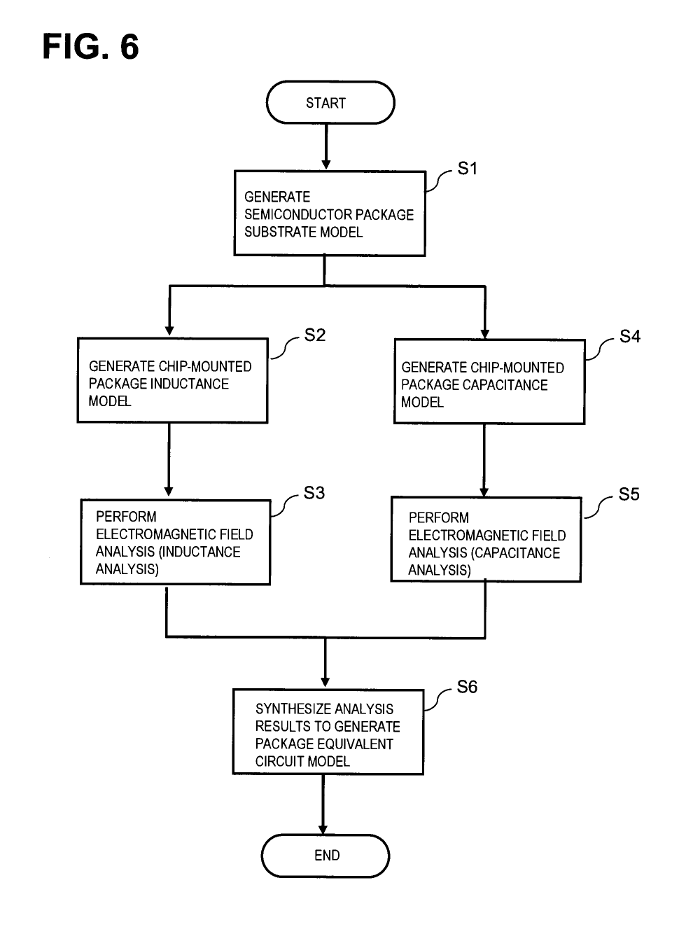

Next, a procedure of determining the equivalent circuit of the semiconductor package using the electromagnetic field analysis device in FIG. 5 will be described by using a flowchart in FIG. 6 indicating an electromagnetic field analysis method. First, in step S1, the semiconductor package substrate model 33 is generated, using the semiconductor package substrate model generation unit 32. Incidentally, the semiconductor package substrate model 33 itself is the same as a substrate model used for conventional electromagnetic field analysis using a semiconductor package model not including a semiconductor chip. Thus, when the semiconductor substrate model itself is already provided, this step S1 may be omitted.

Next, chip-mounted package inductance model generation (in step S2), electromagnetic field analysis (inductance analysis) (in step S3), chip-mounted package capacitance model generation (in step S4), and electromagnetic field analysis (capacitance analysis) (in step S5) are executed. Steps S3 and S5 respectively need to be carried out after steps S2 and S4. Either of steps S2 and S3 and either of steps S4 and S5 may be processed earlier. Steps S2 and S3 and steps S4 and S5 may be concurrently processed.

In step S2, the semiconductor package substrate model 33 and the semiconductor chip design data 34 are supplied to the semiconductor-chip-mounted semiconductor package model generation unit 35, thereby generating the inductance analysis model 36. In step S3, the inductance analysis model 36 is supplied to the electromagnetic field analysis unit 38, thereby generating the inductance component equivalent circuit 39. In step S4, the semiconductor package substrate model 33 and the semiconductor chip design data 34 are supplied to the semiconductor-chip-mounted semiconductor package model generation unit 35, thereby generating the capacitance analysis model 37. In step S5, the capacitance analysis model 37 is supplied to the electromagnetic field analysis unit 38, thereby generating the capacitance component equivalent circuit 40.

After steps S3 and S5 have been finished, the electromagnetic field analysis result synthesis unit 41 synthesizes the inductance component equivalent circuit 39 generated in step S3 and the capacitance component equivalent circuit 40 generated in step S5. The semiconductor package equivalent model 42 can be thereby obtained.

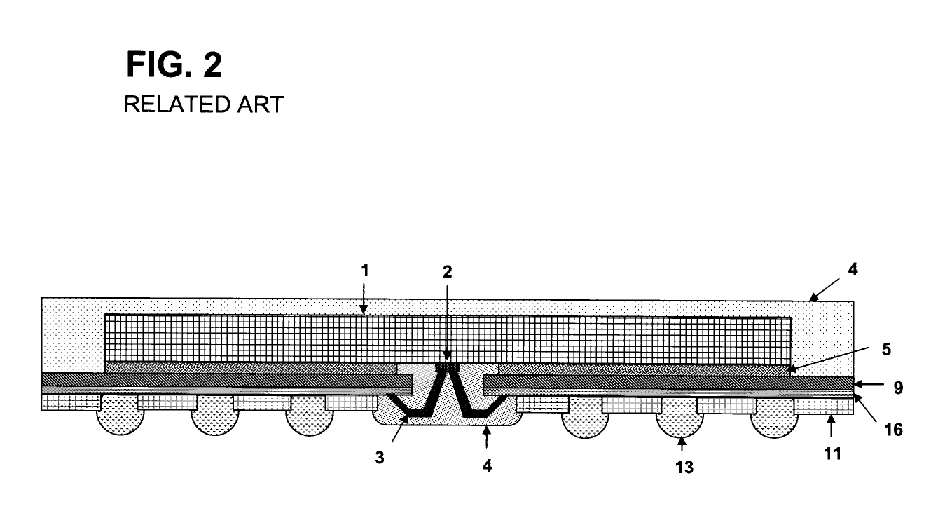

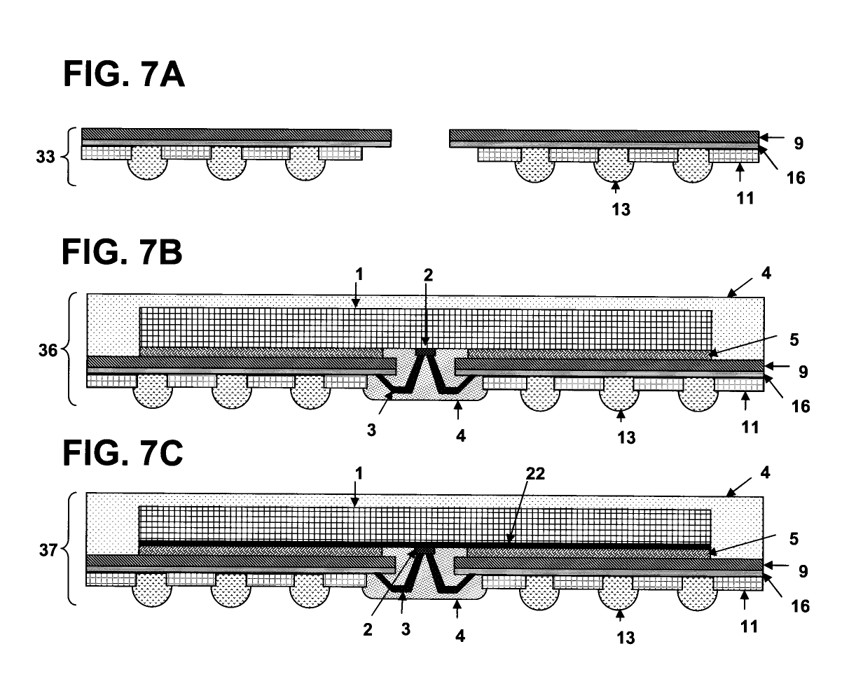

Now, a difference among the semiconductor package substrate model 33, inductance analysis model 36, and capacitance analysis model 37 will be described in further detail. FIGS. 7A, 7B, and 7C are image diagrams schematically showing the semiconductor package substrate model 33, inductance analysis model 36, and capacitance analysis model 37, respectively. FIGS. 7A to 7C assume a package that uses a one-metal-layer wiring substrate in FIG. 2. The semiconductor package substrate model 33 shown in FIG. 7A does not include a semiconductor chip 1. In the inductance analysis model 36 in FIG. 7B, the semiconductor chip 1 is added to the semiconductor package substrate model 33, assuming that the entire semiconductor chip 1 is a dielectric. Further, in the capacitance analysis model 37 in FIG. 7C, the semiconductor chip 1 is added to the semiconductor package substrate model 33, assuming that the semiconductor chip 1 is a dielectric with a metal thin film 22 provided on an overall surface of an entire portion of the semiconductor chip 1 on which at least a wiring layer is provided. As described with reference to FIG. 3, some metal wiring layers are usually provided on a device forming surface of a semiconductor integrated circuit chip. Modeling is carried out, assuming that, in the capacitance analysis model 37, there is the metal thin film on the overall surface where these metal wiring layers are provided. That is, in each of the inductance analysis model 36 and the capacitance analysis model 37, the entire semiconductor chip is added to the semiconductor package substrate model 33 as a different model.

The significance of generating different models regarding the semiconductor chip 1 as described above will be described. As shown in FIG. 3, in the semiconductor chip 1, transistors are usually formed on a surface of the semiconductor substrate made of silicon or the like. Then, the metal wiring layers made of aluminum, copper, or the like for establishing connection between the transistors or outputting a signal to outside are formed on the surface of a layer portion overlaying the transistors. Wirings of these metal wiring layers are extended throughout the entire surface of the silicon substrate each with a wiring width of several dozen to several hundred nm. Most of the surface of the semiconductor chip is covered with metal. For this reason, the metal wiring layers within the semiconductor chip are seen substantially like a metal plane as the capacitance of the wirings on a package substrate. Thus, when the capacitance is determined, a metal plane such as the metal thin film 22 in FIG. 7C is disposed on a side of the surface on which the metal wiring layers of the semiconductor chip are provided. The influence of the semiconductor chip can be thereby simply reflected in the model. There is also a semiconductor chip in which metal wiring layers are provided on a surface (underside) opposite to a surface on which transistors are formed, depending on the semiconductor chip. In such a case, a capacitance analysis model should be generated, assuming that a metal plane (metal thin film) is present on the surface (underside) opposite to the surface on which the transistors are formed.

On the other hand, when modeling is carried out and then analysis of inductance of the wirings on the package substrate is performed assuming that the metal plane layer such as the metal thin film 22 in FIG. 7C is present on the surface, mutual inductance with this metal plane layer is increased because the metal plane layer has a low resistance. Then, the inductance of the wirings on the package substrate influenced by the increase of the mutual inductance is determined to be smaller. However, each of the metal wiring layers within the semiconductor chip is thin with a width of several dozen to several hundred nm. Thus, the metal wiring layers can be handled as a highly resistant conductor. For this reason, the inductance of the wirings on the package substrate influenced by the thin metal wiring layers is increased more than in the case where the metal plane is disposed, and is close to inductance where the metal plane is not present. Thus, the model as shown in FIG. 7B, which handles the entire chip as a dielectric without modeling the metal plane layer on the semiconductor chip, is the model which more closely reflects the actual influence of the semiconductor chip.

The semiconductor package substrate model 33 in FIG. 7A includes only the substrate member 9 of the package substrate, wiring patterns formed on the substrate member 9 (only a package wiring layer 16 in the case of the one-metal-layer wiring substrate), solder resists, and solder balls.

In each of the inductance analysis model 36 in FIG. 7B and the capacitance analysis model 37 in FIG. 7C, the overall semiconductor package including the substrate model 33 in FIG. 7A and further including bonding wires 3, die attach members 5, and a mold resin as well as the semiconductor chip 1 is modeled. When this overall semiconductor package is modeled, data on the quality and thickness of each die attach member, the shape and material (such as the dielectric constant) of the mold resin, and the like, in addition to the semiconductor package substrate model 33 and the semiconductor chip design data 34, may be separately supplied to the semiconductor-chip-mounted semiconductor package model generation unit 35.

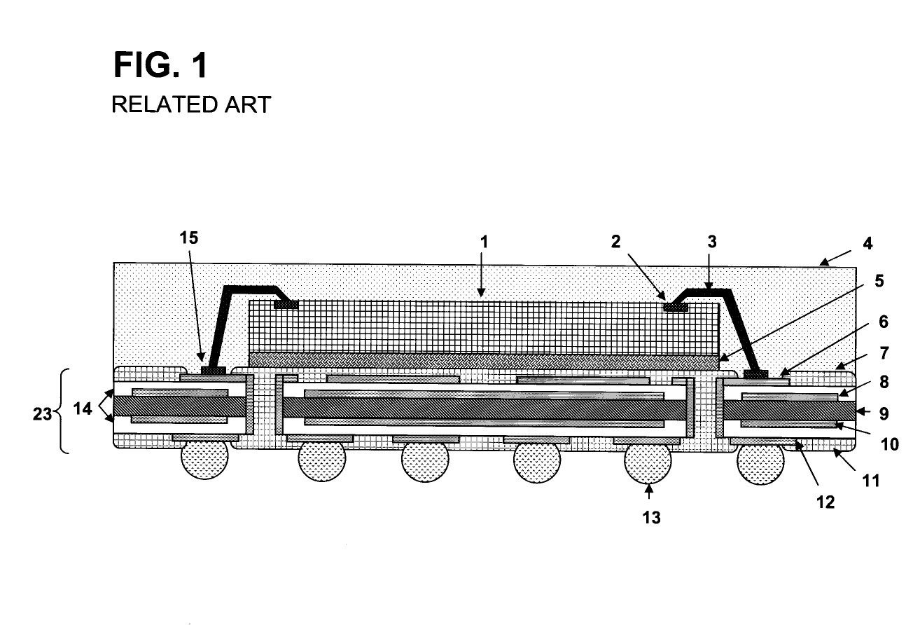

Referring to FIGS. 7A to 7C, the description was given, assuming that the package which uses the one-metal-layer substrate in FIG. 2 is used. In other semiconductor package such as a four-metal-layer substrate in FIG. 1 as well, the inductance analysis model 36 and the capacitance analysis model 37 may be generated with the entire semiconductor chip in the inductance analysis model regarded as the dielectric and with the semiconductor chip regarded as a dielectric having the metal thin film disposed on the surface where the wiring layers of the semiconductor chip are provided.

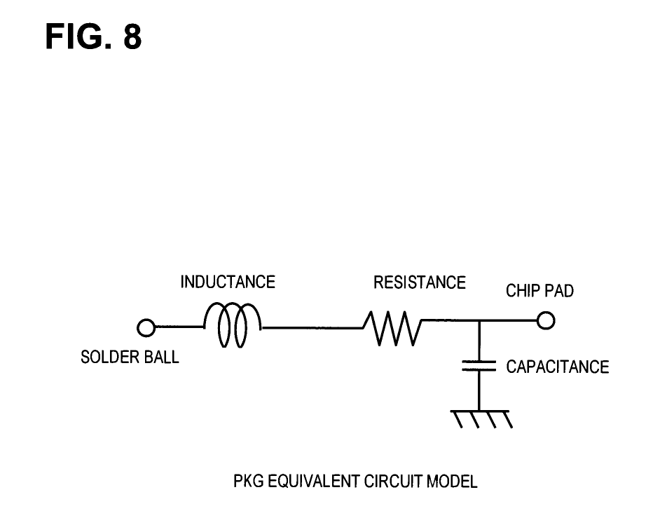

FIG. 8 shows a portion of the semiconductor package equivalent circuit model obtained by the first example. The equivalent circuit model in FIG. 8 shows the model in which an inductance, a resistance, and a capacitance are simply connected between a solder ball 13 and the semiconductor chip pad 2 in FIGS. 7B and 7C. Referring to FIG. 8, the inductance shows only self-inductance. Mutual inductance between conductor patterns is omitted. The capacitance in FIG. 8 shows only the capacitance with respect to the ground. Actually, the mutual inductance and mutual capacitance between the conductor patterns can also be incorporated into the equivalent circuit, as necessary. The equivalent circuit may be generated to have a more elaborate distribution of the inductance, resistance, and capacitance, as necessary.

### Second Example

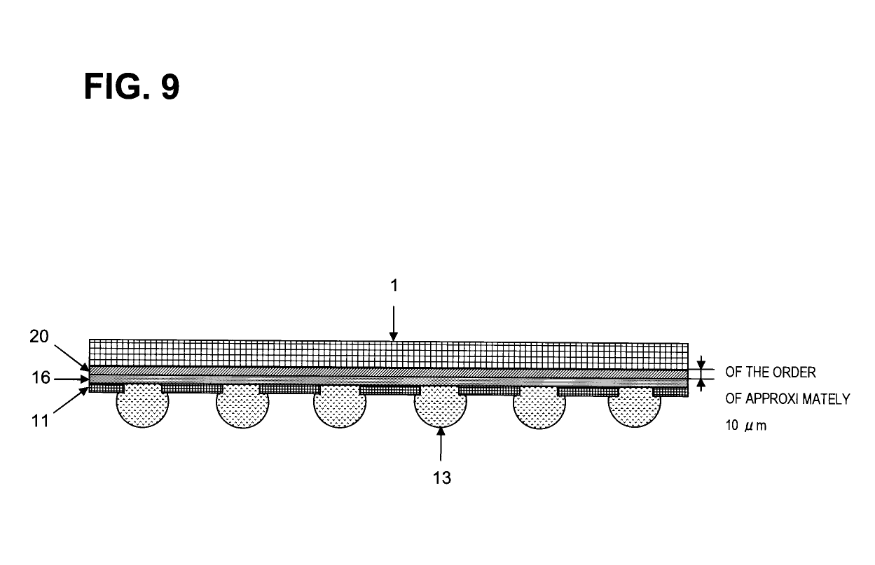

In the first example, the package substrate is provided in advance. Then, an analysis of the semiconductor package of a conventional type with the semiconductor chips mounted thereon is performed using the electromagnetic field analysis method and the electromagnetic field analysis device according to the present invention. The semiconductor chips are obtained by cutting out a semiconductor wafer into individual pieces. However, analysis of a wafer level chip size package (Wafer Level Chip Size Package, which is hereinafter simply referred to as a WLCSP) can also be performed, using the electromagnetic analysis method and the electromagnetic analysis device according to the present invention. FIG. 9 is a sectional view of the WLCSP. In the WLCSP, a dielectric (insulating layer) such as a polyimide 20 is provided on an entire surface of a semiconductor wafer in a state where a lot of semiconductor chips 1 are connected before being cut out into the semiconductor chips 1. Then, a wiring layer 16 for a package substrate is further provided on the insulating layer. After the insulating layer such as the polyimide 20 and the wiring layer 16 for the package substrate have been provided, the semiconductor chips 1 are cut out from the semiconductor wafer, and the resulting package substrate is turned upside down. Finally, a semiconductor package where the semiconductor chip 1 is mounted over wiring layer 16 through the insulating layer of the polyimide 20 or the like, and solder resists 11 and solder balls 13 are provided under the wiring layer 16, as illustrated in FIG. 9, is completed.

In the case of the WLCSP described above, it is not necessary to provide a substrate member 9 of the package substrate and a die attach member 5. Thus, the thickness of the semiconductor package can be reduced. Further, the planar size of the semiconductor package can be made to be substantially the same as the chip size of the semiconductor chip 1. Thus, high-density mounting is possible.

However, the higher the density of mounting is increased as in the WLCSP, the more the distance between the semiconductor chip 1 and the wiring layer 16 of the semiconductor package is reduced. Thus, the presence of the semiconductor chip greatly influences electrical characteristics of the semiconductor package. The thickness of the dielectric such as the polyimide 20 is of the order of approximately 10 μm, as shown in FIG. 9. The semiconductor package in this example greatly differs from the semiconductor package of the conventional type as shown in FIG. 3 in which the thickness of the die attach member 5 is several hundred μm. Electromagnetic field analysis of such a WLCSP can also be performed, using the electromagnetic field analysis method and the electromagnetic analysis device according to the present invention. The second example is different from the first example just in that the structure of the semiconductor package targeted for analysis. As the specific electromagnetic field analysis method and the specific electromagnetic analysis device, details of the first example can be applied without alteration. That is, modeling is carried out with the entire semiconductor chip 1 regarded as the dielectric in the inductance analysis model, and with the semiconductor chip 1 in the capacitance analysis model regarded as having the metal thin film on the overall surface of the semiconductor chip 1 where the wiring layers are provided.

### Third Example

An electromagnetic field analysis method and an electromagnetic field analysis device according to the present invention can also be implemented by installing an electromagnetic field analysis program into a computer such as a supercomputer, an EWS, or a personal computer. By installing the electromagnetic field analysis program according to the present invention into the computer and causing the computer to execute the electromagnetic field analysis program, functions of a semiconductor package substrate model generation unit 32, a semiconductor-chip-mounted semiconductor package model generation unit 35, an electromagnetic field analysis unit 38, an electromagnetic field analysis result synthesis unit 41, and the like in FIG. 5 can be implemented by an arithmetic processing unit of the computer. Further, semiconductor package design data 31, a semiconductor package substrate model 33, semiconductor chip design data 34, an inductance analysis model 36, a capacitance analysis model 37, an inductance component equivalent circuit 39, a capacitance component equivalent circuit 40, and a semiconductor package equivalent circuit model 42 can be implemented by a main storage device of the computer, a hard disk, an optical storage device such as a DVD, a CD, or a flash memory, a magnetic storage device, an opto-magnetic storage device, and an auxiliary storage device of a semiconductor storage device. The storage device may be disposed at a remote location, and input/output can also be performed through a memory or the like at the remote location. The semiconductor chip design data 34 or the like may be interactively supplied through a screen of a terminal of the computer. The semiconductor package equivalent circuit model which is an output may be output by being displayed on the screen of the terminal or being printed on paper.

By causing the computer to function as the analysis device described above, the analysis method described in FIG. 6 can be implemented by the computer, without alteration. The program according to the present invention can be installed into the computer on-line by using the auxiliary storage device, or by using a wired or wireless communication line such as that for the Internet.

### Fourth Example

In the first to third examples, a capacitance analysis is performed, regarding the semiconductor chip as the dielectric in which the metal thin film is provided on the surface where the metal wiring layers are provided. The capacitance component equivalent circuit is thereby determined. An inductance analysis is also performed, regarding the entire semiconductor chip as the dielectric. The inductance component equivalent circuit is thereby determined. Then, by synthesizing the capacitance component equivalent circuit and the inductance component equivalent circuit, the equivalent circuit model of the overall semiconductor package is determined. However, according to the present invention, not only the equivalent circuits can be determined, but also electrical characteristics can be determined without alteration. That is, the electrical characteristics can be determined without alteration by supplying a condition such as an input signal when the equivalent circuits are known.

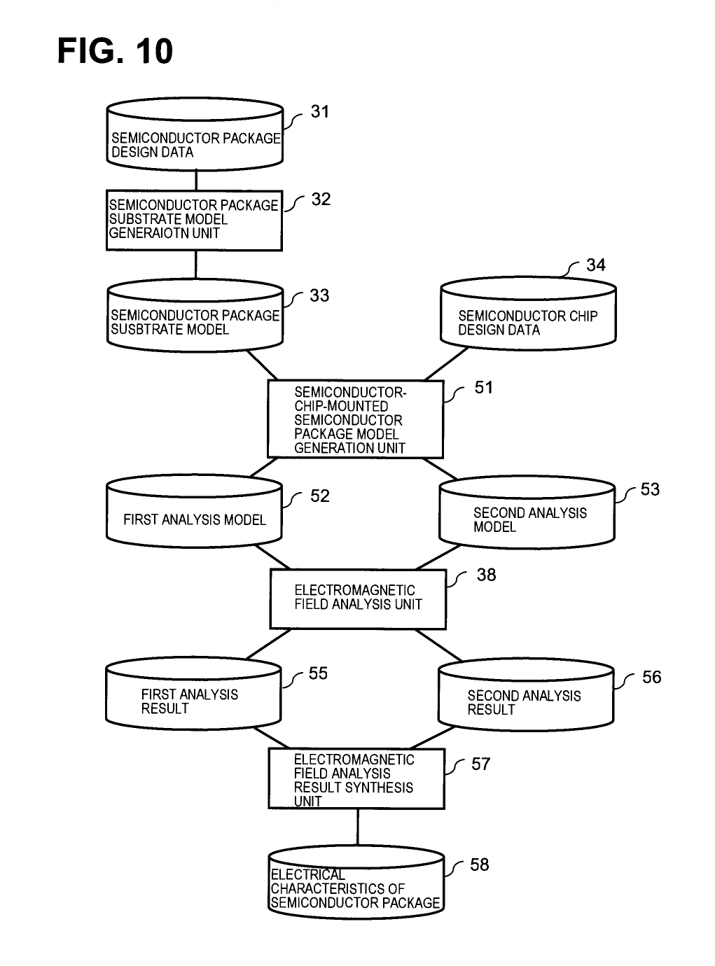

The entire semiconductor chip according to the present invention can be treated as a plurality of different models. Then, by performing electromagnetic field analyses and synthesizing results of the electromagnetic field analyses where the entire semiconductor chip was treated as the plurality of models, the synthesized results can be more extensively utilized for an electromagnetic field analysis of the semiconductor package with the semiconductor chip mounted thereon. That is, since semiconductors (such as silicon having a dielectric constant of 12 and a conductivity of several dozen S/m) are not conductors or insulators, the semiconductors cannot be easily handled in the electromagnetic field analysis. Further, an optimal analysis can be performed in consideration of various metal wirings and insulating layers provided on the semiconductor chip. A configuration and an operation of an analysis device in this fourth example will be described, using FIG. 10. Same reference numerals are assigned to components configured to be the same as those of an analysis device in FIG. 5 in the first example, and descriptions of the components will be omitted.

A semiconductor-chip-mounted semiconductor package model generation unit 51 receives the semiconductor package substrate model 33 and the semiconductor chip design data 34 and then outputs a first analysis model 52 and a second analysis model 53. The first analysis model 52 and second analysis model 53 can be determined by the structure of a semiconductor chip and semiconductor package electrical characteristics 58 to be finally determined.

The electromagnetic field analysis unit 38 is configured to be the same as the electromagnetic analysis unit 38 in FIG. 1. However, when a different analysis model is used, a different analysis result is obtained. In the fourth example, an electromagnetic field analysis is performed based on the first analysis model 52. A first analysis result 55 can be thereby obtained. Further, due to an electromagnetic field analysis based on the second analysis model 53, a second analysis result 56 can be obtained. Finally, by synthesizing the first analysis result 55 and the second analysis result 56 by an electromagnetic field analysis result synthesis unit 57, the semiconductor package electrical characteristics 58 can be obtained.

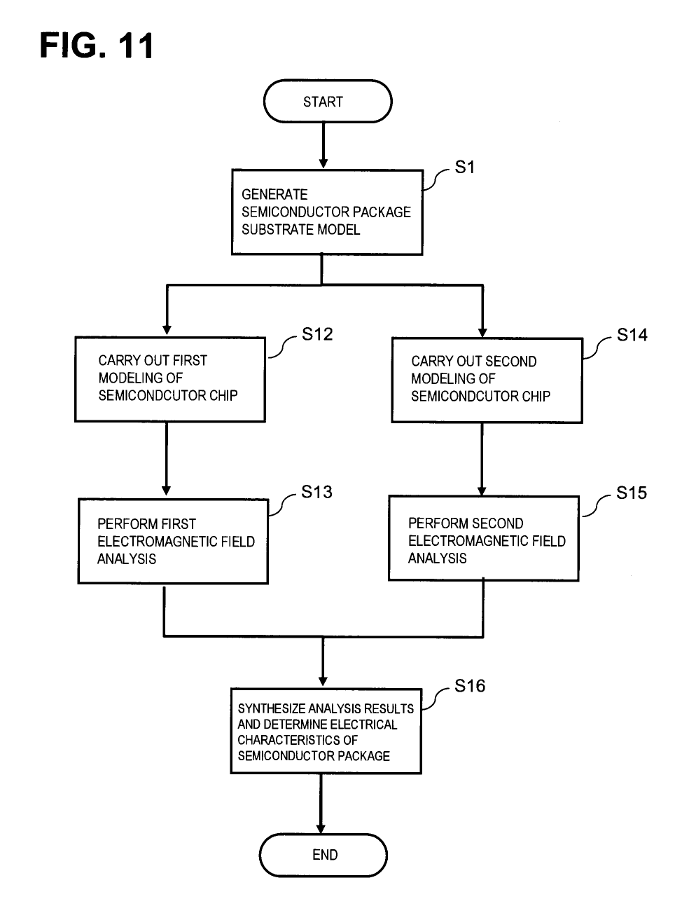

A procedure of performing the analysis using the electromagnetic field analysis device in the fourth example will be shown in a flowchart in FIG. 11. First modeling of the semiconductor chip is carried out (in step S12), and then a first electromagnetic field analysis is performed (in step S13). Second modeling of the semiconductor chip is then carried out (in step S14), and then a second electromagnetic field analysis is performed (in step S15). Finally, by synthesizing results of the first electromagnetic field analysis and the second electromagnetic field analysis, the electrical characteristics of the semiconductor package with the semiconductor chip mounted thereon are determined (in step S16). By the procedure mentioned above, various electrical characteristics for semiconductor chips of various structures can be determined.

Two types of modeling of the semiconductor chip used in FIGS. 10 and 11 to generate the first analysis model and the second analysis model were carried out. The number of the models, however, is not limited to 2. When the accuracy of the analysis is increased using more types of modeling, the number of types of modeling can be increased. A plurality of types of modeling in the present invention refers to a plurality of types of modeling of the entire semiconductor chip. Even if the semiconductor chip divided into a plurality of regions is modeled, the number of types of modeling herein is not increased.

The above description was given in connection with the examples. The present invention is not limited to only the configurations of the examples described above, and of course includes various variations and modifications that could be made by those skilled in the art within the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An electromagnetic field analysis method of semiconductor package performing an electromagnetic field analysis of a semiconductor package with a semiconductor chip mounted thereon, thereby determining electrical characteristics of the semiconductor package, the method comprising:
carrying out first modeling of a semiconductor chip, thereby performing a first electromagnetic field analysis of a semiconductor package;
carrying out second modeling of the semiconductor chip, thereby performing a second electromagnetic field analysis, the second modeling being different from the first modeling; and
determining the electrical characteristics of the semiconductor package with the semiconductor chip mounted thereon from results of the first electromagnetic field analysis and the second electromagnetic field analysis.

2. The semiconductor package electromagnetic field analysis method according to claim 1, wherein
in the first modeling, an entire portion of the semiconductor chip is modeled as a dielectric, and inductance characteristics of the semiconductor package are determined by the first electromagnetic field analysis; and
in the second modeling, the semiconductor chip is modeled as a dielectric with a metal thin film provided on an overall surface of the semiconductor chip where at least a wiring layer is provided, and capacitance characteristics of the semiconductor package are determined by the second electromagnetic field analysis.

3. The semiconductor package electromagnetic field analysis method according to claim 2, wherein
an inductance equivalent circuit of the semiconductor package is determined by the first electromagnetic field analysis;
a capacitance equivalent circuit of the semiconductor package is determined by the second electromagnetic field analysis; and
determining the electrical characteristics of the semiconductor package comprises determining an equivalent circuit of the semiconductor package.

4. The semiconductor package electromagnetic field analysis method according to claim 2, wherein
the semiconductor package is structured such that a wiring layer of a package substrate is in proximity to the wiring layer provided on the surface of the semiconductor chip with a distance of 1 mm or less through an insulating layer.

5. The semiconductor package electromagnetic field analysis method according to claims 2, wherein
in the semiconductor package, no conductive layer is present between the wiring layer of the package substrate and the wiring layer provided on the surface of the semiconductor chip being in proximity to each other through the insulating layer, a potential being supplied to the conductive layer from outside at a time of operation.

6. The semiconductor package electromagnetic field analysis method according to claim 3, wherein
a resistance equivalent circuit of the semiconductor package is further determined by the second electromagnetic field analysis.

7. The semiconductor package electromagnetic field analysis method according to claim 1, wherein
the semiconductor package is a wafer level chip size package.

8. A semiconductor package electromagnetic field analysis device comprising:
a semiconductor-chip-mounted semiconductor package model generation unit that receives a substrate model of a semiconductor package and design data on a semiconductor chip to be mounted on the semiconductor package, and then generates first and second models of the semiconductor package with the semiconductor chip mounted thereon;
an electromagnetic field analysis unit that performs an electromagnetic analysis of each of the first model and the second model and outputs a result of the first electromagnetic field analysis and a result of the second electromagnetic field analysis; and
an electromagnetic field analysis result synthesis unit that synthesizes the result of the first electromagnetic field analysis and the result of the second electromagnetic field analysis, thereby outputting electrical characteristics of the semiconductor package with the semiconductor chip mounted thereon.

9. The semiconductor package electromagnetic field analysis device according to claim 8, wherein
the semiconductor-chip-mounted semiconductor package model generation unit generates as the first model a model that regards an entire portion of the semiconductor chip as a dielectric, and generates as the second model a model that regards the semiconductor chip as a dielectric with a thin film conductor provided on an overall surface of the semiconductor chip where at least a wiring layer is provided; and
the electromagnetic field analysis unit performs the electromagnetic field analysis of the first model and outputs an inductance analysis result of the semiconductor package as the first electromagnetic analysis result, and performs the electromagnetic field analysis of the second model and outputs a capacitance analysis result of the semiconductor package as the second electromagnetic field analysis result.

10. The semiconductor package electromagnetic field analysis device according to claim 8, wherein
the electromagnetic field analysis unit performs the electromagnetic field analysis of the first model and then outputs an inductance component equivalent circuit of the semiconductor package as the first electromagnetic field analysis result, and performs the electromagnetic field analysis of the second model and then outputs a capacitance component equivalent circuit of the semiconductor package as the second electromagnetic field analysis result; and
the electromagnetic field analysis result synthesis unit synthesizes the inductance component equivalent circuit and the capacitance component equivalent circuit, thereby outputting an equivalent circuit of the semiconductor package, as the electrical characteristics of the semiconductor package.

11. A computer-readable storage medium storing a program that causes a computer to execute an electromagnetic field analysis method of semiconductor package, performing an electromagnetic field analysis of a semiconductor package with a semiconductor chip mounted thereon, thereby determining electrical characteristics of the semiconductor package, the method comprising:
carrying out first modeling of a semiconductor chip, thereby performing a first electromagnetic field analysis of a semiconductor package;
carrying out second modeling of the semiconductor chip, thereby performing a second electromagnetic field analysis, the second modeling being different from the first modeling; and
determining the electrical characteristics of the semiconductor package with the semiconductor chip mounted thereon from results of the first electromagnetic field analysis and the second electromagnetic field analysis.

12. The computer-readable storage medium of claim 11, wherein
in the first modeling, an entire portion of the semiconductor chip is modeled as a dielectric, and inductance characteristics of the semiconductor package are determined by the first electromagnetic field analysis; and
in the second modeling, the semiconductor chip is modeled as a dielectric with a metal thin film provided on an overall surface of the semiconductor chip where at least a wiring layer is provided, and capacitance characteristics of the semiconductor package are determined by the second electromagnetic field analysis.

13. The computer-readable storage medium of claim 12, wherein
an inductance equivalent circuit of the semiconductor package is determined by the first electromagnetic field analysis;
a capacitance equivalent circuit of the semiconductor package is determined by the second electromagnetic field analysis; and
determining the electrical characteristics of the semiconductor package comprises determining an equivalent circuit of the semiconductor package.

14. The computer-readable storage medium of claim 12, wherein
the semiconductor package is structured such that a wiring layer of a package substrate is in proximity to the wiring layer provided on the surface of the semiconductor chip with a distance of 1 mm or less through an insulating layer.

15. The computer-readable storage medium of claim 12, wherein
in the semiconductor package, no conductive layer is present between the wiring layer of the package substrate and the wiring layers provided on the surface of the semiconductor chip being in proximity to each other through the insulating layer, a potential being supplied to the conductive layer from outside at a time of operation.

16. The computer-readable storage medium of claim 13, wherein
a resistance equivalent circuit of the semiconductor package is further determined by the second electromagnetic field analysis.

17. The computer-readable storage medium of claim 1, wherein
the semiconductor package is a wafer level chip size package.

18. A computer-readable storage medium storing a program that causes a computer to function as the semiconductor package electromagnetic field analysis device as set forth in claim 8.

19. The computer-readable storage medium of claim 18, wherein
the semiconductor-chip-mounted semiconductor package model generation unit generates as the first model a model that regards an entire portion of the semiconductor chip as a dielectric, and generates as the second model a model that regards the semiconductor chip as a dielectric with a thin film conductor provided on an overall surface of the semiconductor chip where at least a wiring layer is provided; and
the electromagnetic field analysis unit performs the electromagnetic field analysis of the first model and outputs an inductance analysis result of the semiconductor package as the first electromagnetic analysis result, and performs the electromagnetic field analysis of the second model and outputs a capacitance analysis result of the semiconductor package as the second electromagnetic field analysis result.

20. The computer-readable storage medium of claim 18, wherein
the electromagnetic field analysis unit performs the electromagnetic field analysis of the first model and then outputs an inductance component equivalent circuit of the semiconductor package as the first electromagnetic field analysis result, and performs the electromagnetic field analysis of the second model and then outputs a capacitance component equivalent circuit of the semiconductor package as the second electromagnetic field analysis result; and
the electromagnetic field analysis result synthesis unit synthesizes the inductance component equivalent circuit and the capacitance component equivalent circuit, thereby outputting an equivalent circuit of the semiconductor package, as the electrical characteristics of the semiconductor package.
